(19) United States
(12) Patent Application Publication
(10) Pub. No.: US 2024/0426382 A1
(43) Pub. Date: Dec. 26, 2024

(54) VALVE WITH IMPROVED FLOW CONTROL

(71) Applicant: CareFusion 303, Inc., San Diego, CA (US)

(72) Inventors: Wesley Underwood, Anaheim, CA (US); Corey M. Christensen, Anaheim, CA (US)

(21) Appl. No.: 18/337,826

(22) Filed: Jun. 20, 2023

(51) Int. Cl. F16K 5/04; F16K 27/06; F16K 31/60

(52) U.S. Cl. CPC F16K 5/0442; F16K 27/065; F16K 31/602

(57) ABSTRACT

A system that regulates a flow of a fluid through a valve is disclosed. The system includes a flow regulator and a spindle housing. The flow regulator includes a spindle that includes a channel that extends around a portion thereof and a flow adjuster that extends from the spindle. The spindle housing includes an aperture extending therethrough that receives the spindle, an inlet that receives the fluid and an outlet that expels the fluid. The flow regulator is rotatable relative to the spindle housing when the spindle is disposed in the aperture.

### TECHNICAL FIELD

The present disclosure generally relates to a system for regulating a flow of a fluid and, in some embodiments, to a valve with improved flow control.

### SUMMARY

Aspects of the present disclosure provide a system for regulating flow of a fluid including a flow regulator and a spindle housing. The flow regulator including a spindle, the spindle including a channel extending around a portion thereof, and a flow adjuster extending from the spindle; the spindle housing including an aperture extending therethrough configured to receive the spindle, an inlet receiving the fluid, and an outlet expelling the fluid, wherein the flow regulator is rotatable relative to the spindle housing when the spindle is disposed in the aperture.

In accordance with some aspects of the present disclosure, the flow regulator is rotated relative to the spindle housing between an open position and a closed position, wherein a depth of the channel changes as the flow regulator is rotated between the open position and the closed position, wherein the depth of the channel is a maximum depth in the open position, and wherein the depth of the channel is a minimum depth in the closed position.

In accordance with some aspects of the present disclosure, the flow regulator is rotated relative to the spindle housing between an open position and a closed position, wherein a width of the channel changes as the flow regulator is rotated between the open position and the closed position, wherein the width of the channel is a maximum width in the open position, and wherein the width of the channel is a minimum width in the closed position.

In accordance with some aspects of the present disclosure, the inlet and the outlet extend in opposite directions from the aperture. In some aspects, an axis of the inlet and an axis the outlet are on a common plane. In some aspects, the inlet and the outlet are in fluid communication when the flow regulator is in the open position. In some aspects, the inlet and the outlet are not in fluid communication when the flow controller is in the closed position. In accordance with some aspects of the present disclosure, the flow regulator rotates 50° relative to the spindle housing between the open position and the closed position.

In accordance with some aspects of the present disclosure, the flow adjuster is a handle. In some aspects, the handle has a length approximately equal to a length of the spindle. In some aspects, the flow regulator is rotated relative to the spindle housing by a user. In some aspects, the flow regulator is rotated relative to the spindle housing by a machine. In some aspects, the spindle and the spindle housing form a fluid seal. In some aspects, the channel defines a fluid path between the inlet and the outlet.

### BRIEF DESCRIPTION OF THE DRAWINGS

The foregoing summary, as well as the following detailed description of embodiments of the valve with improved flow control, will be better understood when read in conjunction with the appended drawings of exemplary embodiments. It should be understood, however, that the invention is not limited to the precise arrangements and instrumentalities shown.

In the drawings:

FIG. 1 is a perspective view a valve in accordance with exemplary embodiments of the present inventions;

FIG. 2 is a perspective view a spindle housing of the valve of FIG. 1 in accordance with exemplary embodiments of the present inventions;

FIG. 3 is a perspective view a flow regulator of the valve of FIG. 1 in accordance with exemplary embodiments of the present inventions; and

FIG. 4 is a side view of the valve of FIG. 1 being rotated between an open position and a closed position in accordance with exemplary embodiments of the present inventions.

### DETAILED DESCRIPTION

Stopcocks are a common valve used to control the flow of a liquid or gas in numerous applications. Typical stopcocks may include a valve that is opened or close to control flow of the fluid or gas therethrough. This approach, however, typically has limited flow control functionality due to the configuration of the valve itself. A typical stopcock includes a fluid path through a spindle that connects an inlet port and an outlet port, which is very sensitive and can unintentionally prevent fluid from traveling through the valve or, alternatively, can allow more fluid than is desired to travel through the valve. Further, a traditional stopcock only provides approximately 30° of spindle rotation between a fully open and a fully closed position.

Thus, it is desirable to provide a valve with improved flow control that includes a mechanism for improving control of the flow of liquid or gas through the valve. It is also desirable to provide a valve that protects against unintended flow rate adjustment.

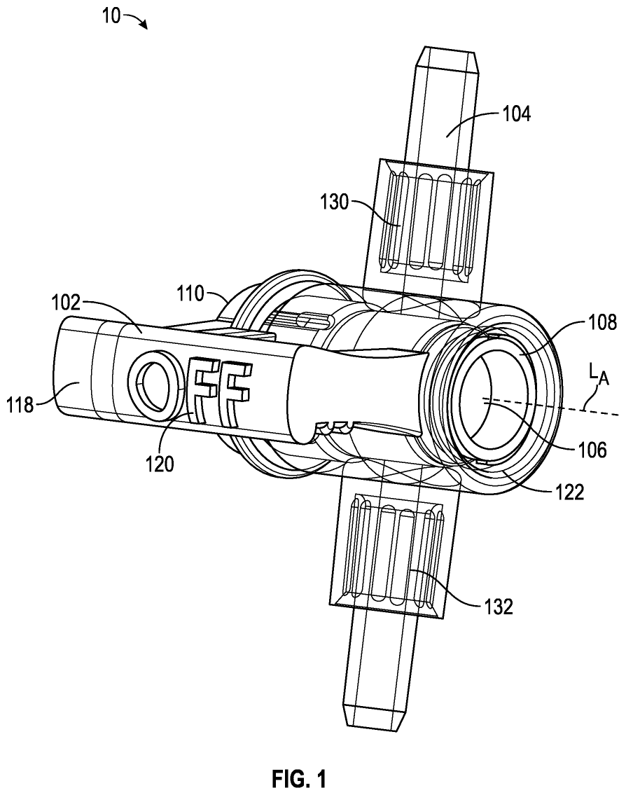

Referring to the drawings in detail, wherein like reference numerals indicate like elements throughout, there is shown in FIGS. 1-4 a valve, generally designated 10, in accordance with an exemplary embodiment of the present invention. As discussed above, typical stopcocks include a fluid path defined through a spindle that connects an inlet port and an outlet port. Valve 10, however, includes a fluid path defined around the spindle that connects an inlet port and an outlet port. Further, the width and depth of the fluid path changes along its length to add increased control of the fluid or gas flow as the spindle is rotated.

Referring to FIG. 1, the valve 10 may include a flow regulator 102 and a spindle housing 104. The flow regulator 102 may include a spindle 106. The spindle 106 may be a generally cylindrical shape. The spindle 106 may have a proximal end 108 and a distal end 110 opposite the proximal end along a longitudinal axis LA thereof. The spindle 106 may be formed from a plastic. The spindle 106 may be formed from a rubber.

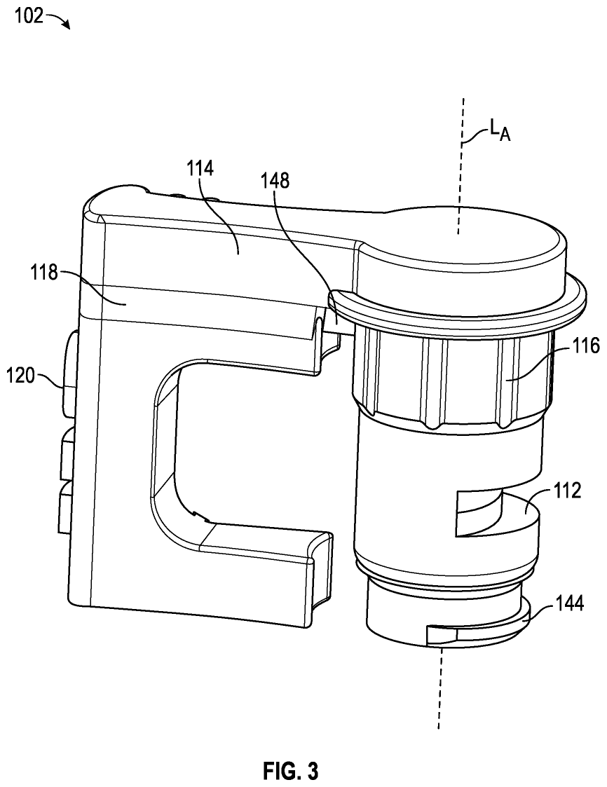

The spindle 106 may include a channel 112 defined therein, as shown in FIG. 3. The channel 112 may extend around at least part of a circumference of the spindle 106. The channel 112 may extend around the circumference of the spindle 106. The channel 112 may be located closer to the proximal end 108 than the distal end 110 of the spindle 106. The channel 112 may be located proximate a center of the spindle 106 between the proximal end 108 and the distal end 110. The channel 112 may be located closer to the distal end 110 than the proximal end 108 of the spindle 106.

The flow regulator 102 may include a flow adjuster 114 extending from the distal end 110 of the spindle 106. The flow adjuster 114 may extend from the proximal end 108 of the spindle 106. The flow adjuster 114 may include a handle 118. The handle 118 may define a generally U shape. The handle 118 may form a generally L-shape. The handle 118 may extend generally parallel to the spindle 106. There may be a space defined between the handle 118 and the spindle 106 to allow the spindle housing 104 to receive the spindle 106.

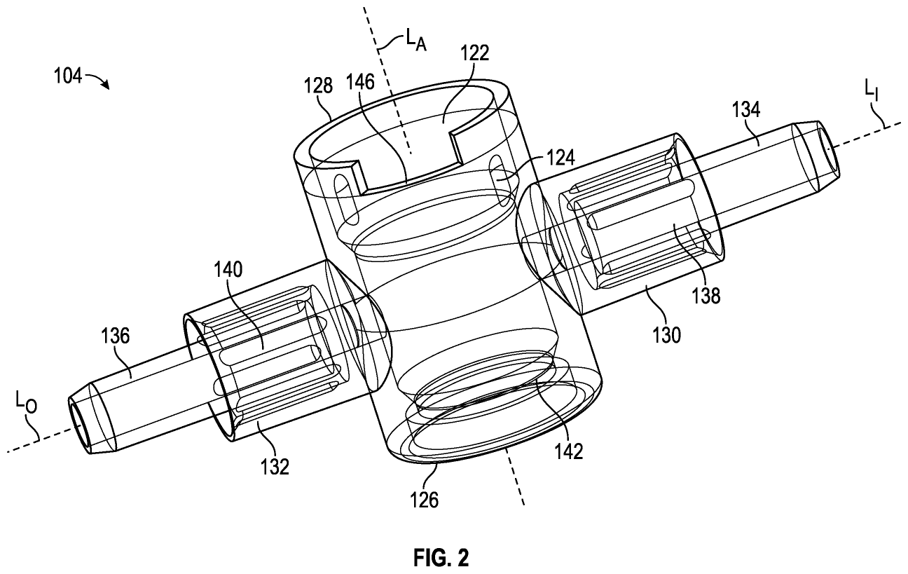

The handle 118 may include indicia 120 disposed thereon. The indicia 120 may protrude from a surface of the handle 118, as shown in FIG. 1. The indicia 120 may be a word, such as “OFF,” as shown. In some embodiments, the indica 120 may be a combination of words and/or symbols. For example, the indica 120 may include an arrow to signify the directions the handle 118 may be moved to increase or decrease flow. The indicia 120 may also include the word “OFF” or a circle-backslash symbol next to an arrow to signify which direction the handle 118 may be moved to limit or stop the flow of the fluid. Further, the indicia 120 may include the word “ON” or a check mark next to an arrow to signify which direction the handle 118 may be moved to increase the flow of the fluid. Such use of symbols instead of letters or words may be more understood by a larger population of users. In some embodiments, the indicia 120 may be generally flush with the surface of the handle 118. In some embodiments, the indicia 120 may be a label or sticker coupled to the surface of the handle 118 by a glue or other adhesive. The indicia 120, whether letters and/or symbols, may be sized such that a user can read the indicia from a distance up to 5 ft. The indicia may be sized such that a user can read the indicia from a distance up to 10 ft. sized such that a user can read the indicia from a distance up to 15 ft. sized such that a user can read the indicia from a distance up to 20 ft. sized such that a user can read the indicia from a distance up to 25 ft. The spindle housing 104 may include an aperture 122 extending therethrough. The aperture 122 may be a generally cylindrical shape. The aperture 122 may be sized and shaped to receive the spindle 106. The spindle 106 and the spindle housing 104 may form a fluid seal when the spindle 106 is received by the aperture 122. As shown in FIG. 2, the aperture 122 may include a protrusion 124 extending therefrom. The aperture 122 may include a plurality of protrusions 124 extending therefrom. The protrusions 124 may be located proximate a distal end 128 of the aperture 122. The protrusions 124 may be located proximate a proximal end 126 of the aperture 122.

There may be a protrusion 124 every 50° around the aperture 122. There may be a protrusion 124 every 45° around the aperture 122. There may be a protrusion 124 every 40° around the aperture 122. There may be a protrusion 124 every 35° around the aperture 122. There may be a protrusion 124 every 30° around the aperture 122. There may be a protrusion 124 every 25° around the aperture 122. There may be a protrusion 124 every 20° around the aperture 122. There may be a protrusion 124 every 15° around the aperture 122. There may be a protrusion 124 every 10° around the aperture 122. There may be a protrusion 124 every 5° around the aperture 122. There may be a protrusion 124 every 4° around the aperture 122. There may be a protrusion 124 every 3° around the aperture 122. There may be a protrusion 124 every 2° around the aperture 122. There may be a protrusion 124 every 1° around the aperture 122. There may be a protrusion 124 every 0.5° around the aperture 122. There may be a protrusion 124 every 0.25° around the aperture 122.

As shown in FIG. 3, the spindle 106 may include the depression 116. The spindle 106 may include a plurality of depressions 116. The depression 116 may extend at least partially along a length of the spindle 106. The depression 116 may extend from the distal end of the spindle 106. The area of the spindle 106 that includes the depression 116 may have a diameter larger than the rest of the spindle 106. The protrusion 124 of the aperture 122 may be sized and shaped to be received in a depression 116 of the spindle 106 when the spindle 106 is disposed in the spindle housing 104. Engagement of the depression 116 in the protrusion 124 may hinder rotation of the flow regulator 102 relative to the spindle housing 104. Engagement of the depression 116 in the protrusion 124 may prevent rotation of the flow regulator 102 relative to the spindle housing 104 until a threshold force is applied to the flow adjuster 114.

There may be a depression 116 every 50° around the spindle 106. There may be a depression 116 every 45° around the spindle 106. There may be a depression 116 every 40° around the spindle 106. There may be a depression 116 every 35° around the spindle 106. There may be a depression 116 every 30° around the spindle 106. There may be a depression 116 every 25° around the spindle 106. There may be a depression 116 every 20° around the spindle 106. There may be a depression 116 every 15° around the spindle 106. There may be a depression 116 every 10° around the spindle 106. There may be a depression 116 every 5° around the spindle 106. There may be a depression 116 every 4° around the spindle 106. There may be a depression 116 every 3° around the spindle 106. There may be a depression 116 every 2° around the spindle 106. There may be a depression 116 every 1° around the spindle 106. There may be a depression 116 every 0.5° around the spindle 106. There may be a depression 116 every 0.25° around the spindle 106.

Referring to FIG. 2, the spindle housing 104 may include an inlet 130 for receiving a fluid. The spindle housing 104 may include an outlet 132 for expelling the fluid. The inlet 130 and outlet 132 may extent in opposite directions from the aperture 122. An axis L_{I} extending through and inlet 130 and an axis L_{O} extending through the outlet 132 may be on a common plane. The axis Ly and the axis L_{O} may be approximately 180° relative to each other. The inlet 130 and outlet 132 may be generally cylindrical shaped. The inlet 130 may include an inlet port 138 for receiving an inlet tubing 134 and the outlet 132 may include an outlet port 140 for receiving an outlet tubing 136. The ports 138, 140 may include a protrusion extending from an interior surface to fix the tubing 134, 136 to the ports 138, 140. The protrusions of the ports 138,140 may prevent the tubing 134, 136 from rotating relative to the ports 138, 140 when the tubing is disposed therein.

The spindle housing 104 may include a collar 142 extending radially inward from the aperture 122. The collar 142 may be located proximate the proximal end 126 of the aperture 122. The collar 142 may extend around and entire circumference of the aperture 122. The collar 142 may extend around only a portion of the circumference of the aperture 122. The collar 142 may be shaped and sized such that a lip 144 of the spindle 106 (shown in FIG. 3) may pass over the collar 142 when the spindle 106 is disposed in the spindle housing 104. The collar 142 may prevent the spindle 106 from moving longitudinally relative to the spindle housing 104. The collar 142 may prevent the spindle 106 from unintentionally moving longitudinally relative to the spindle housing 104. The region of the spindle 106 that includes the collar 142 may have a diameter less than the rest of the spindle 106.

The spindle housing 104 may include a recess 146 at the distal end 126 thereof. The aperture 122 may extend around a portion of the spindle housing 104. The recess 146 may be shaped and sized to receive a stop 148 extending proximally along the longitudinal axis LA from the handle 118. The recess 146 may limit the rotation of the flow regulator 102 relative to the spindle housing 104 to control the flow of the fluid traveling through the valve 10.

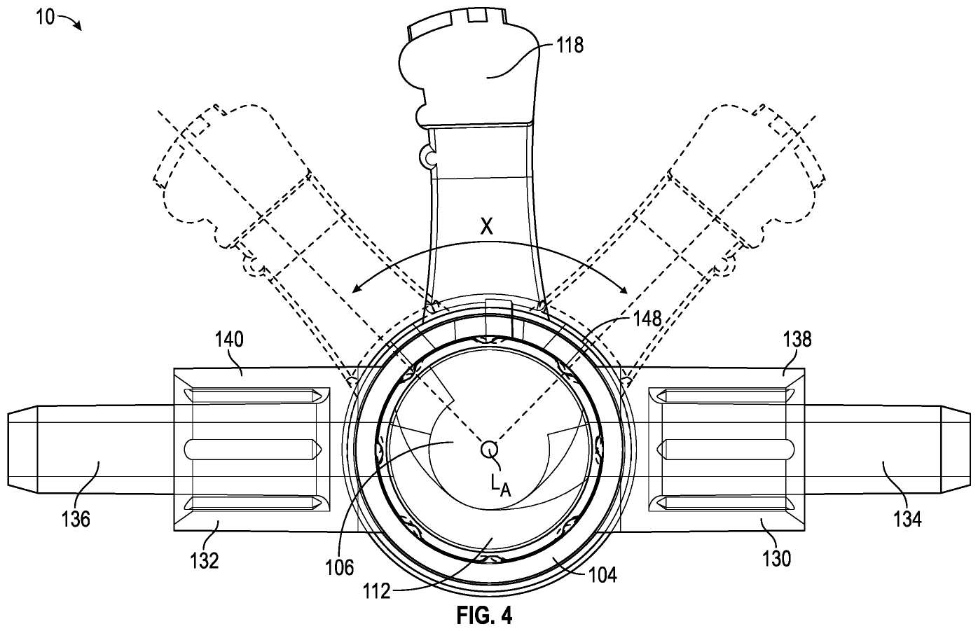

As shown in FIG. 4, the stop 148 may engage the recess 146 at an open position and at a closed position. A depth of the channel 112 may change as the flow regulator 102 is rotated between the open position and the closed position. The depth of the channel 112 may be a maximum depth when the flow regulator 102 is in the open position. The depth of the channel 112 may be a minimum depth when the flow regulator 102 is in the closed position. Rotation of the flow regulator 102 between the open position and the closed position, thereby adjusting the depth of the channel 112, may allow a user to adjust the rate by which a fluid flows through the valve 10 to a very high degree.

A width of the channel 112 may change as the flow regulator 102 is rotated between the open position and the closed position. The width of the channel 112 may be a maximum width when the flow regulator 102 is in the open position. The width of the channel 112 may be a minimum width when the flow regulator 102 is in the closed position. Rotation of the flow regulator 102 between the open position and the closed position, thereby adjusting the width of the channel 112, may allow a user to adjust the rate by which a fluid flows through the valve 10 to a very high degree.

The inlet 130 and the outlet 132 may be in fluid communication when the flow regulator 102 is in the open position. The inlet 130 and the outlet 132 may be in fluid communication when the flow regulator 102 is rotated from the closed position toward the open position. The inlet 130 and the outlet 132 may not be in fluid communication when the flow regulator 102 is in the closed position. The flow regulator 102 may be rotated relative to the spindle housing 104 by a user. The flow regulator 102 may be rotated relative to the spindle housing 104 by a machine. The channel 112 may form a fluid path between the inlet 130 and the outlet 132.

The angle X that the flow regulator 102 can rotate about the longitudinal axis LA relative to the spindle housing 104 may be approximately 50° between the open position and the closed position. Angle X may be approximately 30°. Angle X may be approximately 35°. Angle X may be approximately 40°. Angle X may be approximately 45°. Angle X may be approximately 55°. Angle X may be approximately 60°. Angle X may be between 30° and 60°. Angle X may be between 30° and 40°. Angle X may be between 40° and 50°. Angle X may be between 50° and 60°.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a,” “an,” and “the” are not limited to one element but instead should be read as meaning “at least one.” Finally, unless specifically set forth herein, a disclosed or claimed method should not be limited to the performance of their steps in the order written, and one skilled in the art can readily appreciate that the steps may be performed in any practical order.

What is claimed is:

1. A system for regulating a flow of a fluid comprising:
a flow regulator comprising:
a spindle, the spindle comprising a channel extending around a portion thereof, and
a flow adjuster extending from the spindle; and
a spindle housing comprising:
an aperture extending therethrough configured to receive the spindle,
an inlet receiving the fluid, and
an outlet expelling the fluid;
wherein the flow regulator is rotatable relative to the spindle housing when the spindle is disposed in the aperture.

2. The system of claim 1, wherein the flow regulator is rotated relative to the spindle housing between an open position and a closed position.

3. The system of claim 2, wherein a depth of the channel changes as the flow regulator is rotated between the open position and the closed position.

4. The system of claim 3, wherein the depth of the channel is a maximum depth in the open position.

5. The system of claim 3, wherein the depth of the channel is a minimum depth in the closed position.

6. The system of claim 2, wherein a width of the channel changes as the flow regulator is rotated between the open position and the closed position.

7. The system of claim 6, wherein the width of the channel is a maximum width in the open position.

8. The system of claim 6, wherein the width of the channel is a minimum width in the closed position.

9. The system of claim 2, wherein the inlet and the outlet extend in opposite directions from the aperture.

10. The system of claim 9, wherein an axis of the inlet and an axis the outlet are on a common plane.

11. The system of claim 2, wherein the inlet and the outlet are in fluid communication when the flow regulator is in the open position.

12. The system of claim 2, wherein the inlet and the outlet are not in fluid communication when the flow controller is in the closed position.

13. The system of claim 2, wherein the flow regulator rotates 50° relative to the spindle housing between the open position and the closed position.

14. The system of claim 1, wherein the flow adjuster is a handle.

15. The system of claim 14, wherein the handle has a length approximately equal to a length of the spindle.

16. The system of claim 1, wherein the flow regulator is rotated relative to the spindle housing by a user.

17. The system of claim 1, wherein the flow regulator is rotated relative to the spindle housing by a machine.

18. The system of claim 1, wherein the spindle and the spindle housing form a fluid seal.

19. The system of claim 1, wherein the channel defines a fluid path between the inlet and the outlet.

20. A system for regulating a flow of a fluid comprising:
a flow regulator comprising:
a spindle, the spindle comprising a channel extending around a portion thereof, and
a flow adjuster extending from the spindle; and
a spindle housing comprising:
an aperture extending therethrough configured to receive the spindle,
an inlet receiving the fluid, and
an outlet expelling the fluid;
wherein the flow regulator is rotatable relative to the spindle housing when the spindle is disposed in the aperture; and
wherein the flow regulator is rotated relative to the spindle housing between an open position and a closed position.
